(19) United States
(12) Patent Application Publication
(10) Pub. No.: US 2026/0295457 A1
(43) Pub. Date: Oct. 1, 2026

(54) Systems, Devices, and Methods for Electrical Generation from Vacuum Distillation

(71) Applicant: American Water and Energy LLC, Cheyenne, WY (US)

(72) Inventor: Derald McCabe, Katy, TX (US)

(21) Appl. No.: 19/566,189

(22) Filed: Mar. 13, 2026

Related U.S. Application Data
(60) Provisional application No. 63/771,271, filed on Mar. 13, 2025.

(51) Int. Cl. B01D 3/00; B01D 3/10; B01D 5/00; C02F 1/06; C02F 1/20; C02F 1/463; C02F 9/00; H02K 7/18

(52) U.S. Cl. CPC B01D 3/007; B01D 3/10; B01D 5/006; B01D 5/0069; C02F 1/06; C02F 9/00; H02K 7/1823; C02F 1/20; C02F 1/463; C02F 2303/10

(57) ABSTRACT

Systems, devices, and methods that produce electricity from a vacuum distillation process are provided in accordance with various embodiments. The various systems, devices, and methods may generally include one or more vacuum distillation components and one or more electrical generation components. The vacuum distillation may generally include an evaporator, a pump, and/or a condenser, for example. The electrical generation may include a rotating assembly, such as a vapor turbine, and an electrical generator.

### CROSS-REFERENCES TO RELATED APPLICATIONS

This application is a non-provisional patent application claiming priority benefit of U.S. provisional patent application Ser. No. 63/771,271, filed on Mar. 13, 2025 and entitled “SYSTEMS, DEVICES, AND METHODS FOR ELECTRICAL GENERATION FROM VACUUM DISTILLATION,” the entire disclosure of which is herein incorporated by reference for all purposes.

### BACKGROUND

Vacuum distillation may be utilized for a wide variety of purposes such as purifying various wastewater streams. There may be a need for new tools and techniques to improve the vacuum distillation process and/or provide additional benefits.

### SUMMARY

are provided in accordance with various embodiments. For example, some embodiments include a method that includes forming a vapor from a vacuum distillation process and driving an electrical generator utilizing the vapor from the vacuum distillation process. The method may include condensing the vapor after driving the electrical generator utilizing the vapor from the vacuum distillation process. Forming the vapor from the vacuum distillation process may include heating a fluid. An expansion contraction ratio between forming the vapor from the vacuum distillation process and condensing the vapor may build pressure to drive the electrical generator. Some embodiments further include utilizing a pump to hold a vacuum intensity with respect to the vacuum distillation process.

A wide variety of fluids may be utilized with respect to the method. For example, the fluid may include a wastewater stream. Some embodiments include pretreating the fluid prior to forming the vapor from the vacuum distillation process utilizing at least an electro-coagulation process or an electrolysis process. Some embodiments include removing dissolved gases from the fluid prior to forming the vapor from the vacuum distillation process. Some embodiments include removing droplets from the vapor between forming the vapor from the vacuum distillation process and driving the electrical generator utilizing the vapor from the vacuum distillation. Some embodiments include vibrating at least a plate or a screen positioned within the fluid as part of removing the dissolved gases from the fluid prior to forming the vapor from the vacuum distillation process. The vibrating plate or screen may further facilitate gas removal from the fluid. Some embodiments include a membrane across the vibrating plate, such as a reverse osmosis membrane. The membrane may further facilitate creating a cleaner fluid, such as cleaner water. Some embodiments include features as part of the degasser to facilitate access to the membrane for installation and removal purposes.

Some embodiments include a system that includes a vacuum distiller and an electrical generator coupled with the vacuum distiller such that vapor from the vacuum distiller drives the electrical generator. In some embodiments, the vacuum distiller includes an evaporator that produces the vapor through heating a fluid. In some embodiments, the vacuum distiller includes a condenser that condenses the vapor produced from the evaporator, wherein an expansion contraction ratio between the evaporator and the condenser of the vacuum distiller builds pressure to drive the electrical generator. Some embodiments include a pump coupled with the vacuum distiller to hold a vacuum intensity for the system. In some embodiments, the electrical generator includes a vapor turbine.

A wide variety of fluids may be utilized within the system. For example, the fluid may include a wastewater stream. Some embodiments include at least an electro-coagulation device or an electrolysis device positioned to pre-treat the fluid prior to the vapor from the vacuum distiller driving the electrical generator. Some embodiments include a degas column positioned to remove dissolved gases from the fluid prior to the vapor from the vacuum distiller driving the electrical generator. Some embodiments include one or more mist eliminators positioned in at least an upper portion of the evaporator or the degas column.

Some embodiments include at least a vibrating plate or a vibrating screen positioned at the upper portion of the degas column below a fluid level of the fluid in the degas column. The vibrating plate or screen may further facilitate gas removal from the fluid. Some embodiments include a membrane across the vibrating plate or screen, such as a reverse osmosis membrane. The membrane may further facilitate creating a cleaner fluid, such as cleaner water. Some embodiments include features as part of the degasser to facilitate access to the membrane for installation and removal purposes.

Some embodiments include an evaporator, such as a vaporization chamber, an expansion chamber, or an evaporation chamber, that may produce vapor through heating a fluid, such as a wastewater stream, as part of a distillation process. The vapor may be directed to a condenser, such as a heat exchanger, that may condense the vapor. The expansion contraction ratio between the evaporator side and the condenser side may build up enough pressure to drive an electrical generator, such as through a vapor turbine being positioned in the path of the vapor between the evaporator and the condenser. The rotation of the vapor turbine may generally drive the electrical generator. A pump, such as a vacuum pump, may also be coupled with the system, which may hold the vacuum intensity, while the heating and the cooling of the distillation process may generally move the vapor volume to drive the electrical generation.

Some embodiments include additional components. For example, some embodiments include a degasser to remove dissolved gases from the wastewater stream.

Some embodiments include an electro-coagulation device or other electrolysis device to pre-treat the wastewater stream. The wastewater stream may include a wide variety of streams including, but not limited to, water with one or more contaminants, salt water, and/or produced water.

Some embodiments include methods, systems, and/or devices as described in the specification and/or shown in the figures.

The foregoing has outlined rather broadly the features and technical advantages of embodiments according to the disclosure in order that the detailed description that follows may be better understood. Additional features and advantages will be described hereinafter. The conception and specific embodiments disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of different embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A shows a system in accordance with various embodiments.

FIG. 1B shows a system in accordance with various embodiments.

FIG. 2A shows a system in accordance with various embodiments.

FIG. 2B shows a device in accordance with various embodiments.

FIG. 3 shows a system in accordance with various embodiments.

FIG. 4 shows a system in accordance with various embodiments.

FIG. 5 shows a system in accordance with various embodiments.

FIG. 6 shows a system in accordance with various embodiments.

FIG. 7A shows a method in accordance with various embodiments.

FIG. 7B shows a method in accordance with various embodiments.

FIG. 7C shows a method in accordance with various embodiments.

### DETAILED DESCRIPTION

This description provides embodiments, and is not intended to limit the scope, applicability, or configuration of the disclosure. Rather, the ensuing description will provide those skilled in the art with an enabling description for implementing embodiments of the disclosure. Various changes may be made in the function and arrangement of elements.

Thus, various embodiments may omit, substitute, or add various procedures or components as appropriate. For instance, it should be appreciated that the methods may be performed in an order different than that described, and that various stages may be added, omitted, or combined. Also, aspects and elements described with respect to certain embodiments may be combined in various other embodiments. It should also be appreciated that the following systems, devices, and methods may individually or collectively be components of a larger system, wherein other procedures may take precedence over or otherwise modify their application.

Systems, devices, and methods that produce electricity from a vacuum distillation process are provided in accordance with various embodiments. The various systems, devices, and methods may generally include one or more vacuum distillation components and one or more electrical generation components. The vacuum distillation may generally include an evaporator, a pump, and/or a condenser, for example. The electrical generation may include a rotating assembly, such as a vapor turbine, and an electrical generator.

Some embodiments include an evaporator, such as a vaporization chamber, an expansion chamber, or an evaporation chamber, that may produce vapor through heating a fluid, such as a wastewater stream, as part of a distillation process. The vapor may be directed to a condenser, such as a cold heat exchanger, that may condense the vapor. The expansion contraction ratio between the evaporator side and the condenser side may build up enough pressure to drive an electrical generator, such as through a vapor turbine that is positioned in the path of the vapor between the evaporator and the condenser. The rotation of the vapor turbine may generally drive the electrical generator. A pump, such as a vacuum pump, may also be coupled with the system, which may hold the vacuum intensity, while the heating and the cooling of the distillation process may generally move the vapor volume to drive the electrical generation.

Some embodiments include additional components. For example, some embodiments include a degasser to remove dissolved gases from the wastewater stream. Some embodiments include an electro-coagulation device or other electrolysis device to pre-treat the wastewater stream. The wastewater stream may include a wide variety of streams including, but not limited to, water with one or more contaminants, salt water, and/or produced water.

Some embodiments produce electricity utilizing a variable vacuum distillation system that may generally be utilized to purify a wastewater stream. Although the specific purification apparatus and method disclosed in some embodiments may be directed to purifying tap water, the methods, systems, and devices disclosed may be adaptable to the distillation of sewage effluent, steep water, produced water, and other solutions of contaminated water.

In some embodiments, a fluid is placed in a tower or column. The fluid placed in a tower or column may be subjected to a high vacuum. The fluid may be heated at the lower part of the tower and cooled near the top of the tower. A gas may be removed and a solid may be precipitated. The fluid may be placed in a vaporization chamber. The fluid placed in the vaporization chamber may be subjected to a high vacuum. A temperature of the fluid may be at or above the boiling point of water at a chamber pressure. The selected pressures and temperatures in the vaporization chamber may be varied as desired to account for peculiarities in the fluid, such as close boiling points of two compounds, or to accommodate restrictions on available heat or power to drive the vacuum pumps to reduce pressure in the system. Vapor evaporated from the vaporization chamber may be pumped to a condenser that may cool the water vapor to below its boiling point. Typically, one or more components related to electrical generation may be positioned between the vaporization chamber and the condenser to produce electricity utilizing the vapor as it moves from the vaporization chamber to the condenser. Distillate water may then be pumped to a storage tank that may also be placed under a vacuum to maintain the purified water in a pure, degassed condition.

Some embodiments include a vacuum distiller that may include several parts. For example, some embodiments include an automatic fill valve such as motor controlled ball valve, gate valve, solenoid valve, etc. Some embodiments include a liquid level control sensor, such as float switch, radar switch etc. Some embodiments include an electro-coagulation device that may aid in the degassing and metal/mineral separation. Some embodiments include a degassing column that may allow reduced pressure or vacuum to remove gases from the water prior to the distillation process. Some embodiments include a distillation expansion chamber that may allow for the expansion of water from a liquid phase to a gas phase and a conduit for removal of the gases from the expansion chamber. Some embodiments include piping and/or conduit that may direct the water gas to the condensing/heat exchanger to cause condensation of water gas phase back to liquid phase. Some embodiments include a solids removal pump that may be activated by a solids level sensor or timer to remove collected solid materials for further use or disposal. Some embodiments include a clean water collection vessel that may be used for collection and distribution of clean water. Some embodiments include a liquid level switch that may be utilized for shut down in case of mechanical failure that may cause the distiller to overfill. Some embodiments include a condensing system that may include a radiator or similar device that may circulate the water through for heat rejection, a circulation pump, and a fan to blow air through the radiator.

Some embodiments include a vacuum distiller that may be totally automatic. For example, the operation of a system may include turning on the main breaker and pushing the on switch. This may generally start the chain of events as follows. The vacuum pump may engage and begin evacuating the system. When the vacuum has reached a preset operating pressure range (minimum 17 in. Hg., maximum 29.6 in Hg., for example), the automatic fill valve and the E/C unit may engage, and water, such as wastewater, flow may begin filling the system. The wastewater may first fill the E/C unit before being directed into the expansion chamber, where the wastewater level may be controlled by the water level sensor. When the water level sensor has reached the desired level, the sensor may close the inlet valve and may engage the heating element to begin adding the necessary heat to evaporate the wastewater and allow the vapor to be pulled through the system to the condensing system. The condensing system may include a circulating coolant pump and/or a radiator with fan for heat rejection. As the vapors are pulled through the condensing system, the vapor may condense to water and this action may help maintain the vacuum pressure that is desired for operation. As the vapors are condensed into water, the collection vessel may begin to fill until it makes contact with the clean water sensor, for example. At this point, the sensor may engage the discharge pump and may begin to discharge the clean water for use or storage. If the water is not discharged in a predetermined time limit, the timer may stop the system until water may be discharged in sufficient quantity to reset the clean water sensor.

To equip the vacuum distiller with electrical generation capabilities, a rotary turbine may be placed in the vapor flow in line prior to entry into the heat exchanger or condensing system. As the water vapor is pulled through the system, the volume and evaporation pressure combined with the suction pressure of the vacuum pump may provide sufficient flow and pressure to cause the rotating vapor turbine to rotate and thereby turn the generator and provide electrical energy for use outside of the system or for internal advantage in the system.

As generally noted, various embodiments utilize vapor and/or steam as part of the distillation and/or electrical generation process. Water in its pure form generally has a non-compressible advantage when it is thoroughly degassed. Water also generally has an expansion ratio of 1728 to 1 in some conditions (such as general atmospheric conditions).

This generally indicates that one cubic foot of water, when expanded into vapor at 212 F., may occupy 1728 cubic feet of vapor. As the pressure decreases when the vacuum is applied, the expansion ratio generally increases to accommodate the reduction in pressure. As an example of the increase, when you operate at 27.886 inches of mercury vacuum pressure the expansion ratio may be 333.60 cubic feet per pound, while the expansion ratio at sea level may be 26.8 cubic feet per pound. This differential generally involves higher volumes of vapor to move through the system that may allow higher volumes of water to be processed. The higher volumes may be maintained by reduction of volume via the condensing process. As water vapor condenses, the space that was fully occupied generally shrinks to a volume equal to the condensing medium temperature. For example, if the evaporation temperature is 140 F. and the condensing temperature is 75 F., the vacuum recreated by the condensing vapor may be approximately 27.886 inches of mercury.

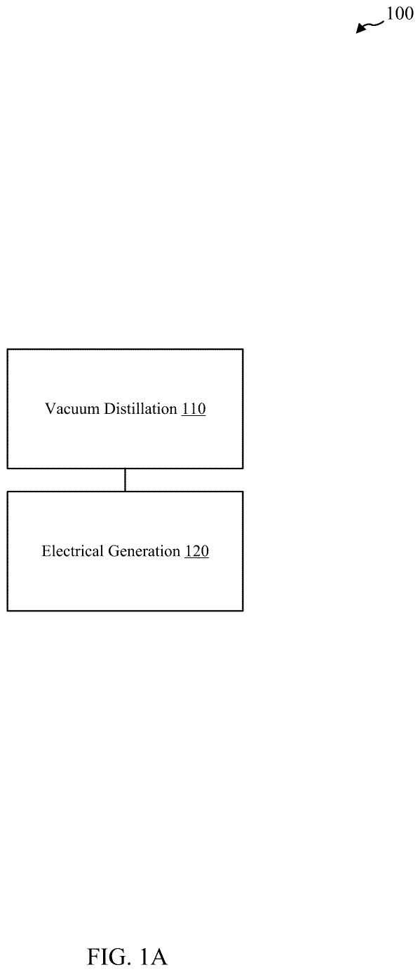

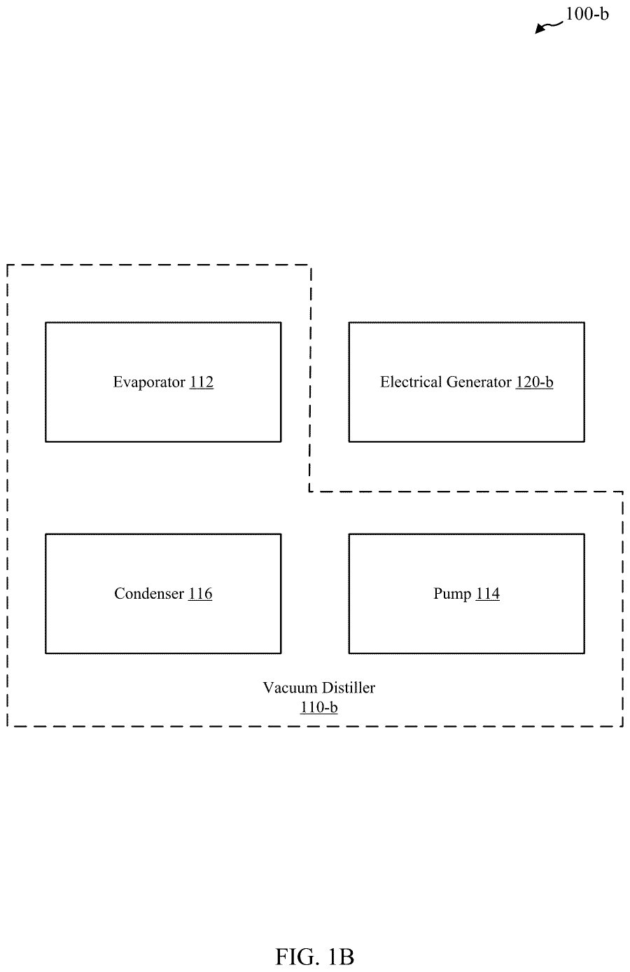

Turning now to FIG. 1A, a system 100 is provided in accordance with various embodiments. System 100 may include vacuum distillation 110 and electrical generation 120. Generally, one or more vapor streams produced from the vacuum distillation 110 may drive one or more components of the electrical generation 120 to produce the electricity as described in more detail herein.

For example, the vacuum distillation 110 may include a vacuum distiller and the electrical generation 120 may include an electrical generator coupled with the vacuum distiller such that vapor from the vacuum distiller drives the electrical generator. In some embodiments, the vacuum distiller includes an evaporator that produces the vapor through heating a fluid. In some embodiments, the vacuum distiller includes a condenser that condenses the vapor produced from the evaporator, wherein an expansion contraction ratio between the evaporator and the condenser of the vacuum distiller builds pressure to drive the electrical generator. Some embodiments include a pump coupled with the vacuum distiller to hold a vacuum intensity for the system. In some embodiments, the electrical generator includes a vapor turbine.

A wide variety of fluids may be utilized within the system. For example, the fluid may include a wastewater stream. Some embodiments include at least an electro-coagulation device or an electrolysis device positioned to pre-treat the fluid prior to the vapor from the vacuum distiller driving the electrical generator. Some embodiments include a degas column positioned to remove dissolved gases from the fluid prior to the vapor from the vacuum distiller driving the electrical generator. Some embodiments include one or more mist eliminators positioned in at least an upper portion of the evaporator or the degas column. Some embodiments include at least a vibrating plate or a vibrating screen positioned at the upper portion of the degas column below a fluid level of the fluid in the degas column.

Turning now to FIG. 1B, a system 100-b is provided in accordance with various embodiments. System 100-b may be an example of system 100 of FIG. 1A. System 100-b may include vacuum distiller 110-b and electrical generator 120-b. The vacuum distiller 110-b may include an evaporator 112, a condenser 116, and a pump 114. The evaporator 112 may also be referred to as a vaporization chamber, an expansion chamber, or an evaporation chamber. The evaporator 112 may produce vapor through heating a fluid, such as a wastewater stream, as part of distillation process. The wastewater stream may include a wide variety of streams including, but not limited to, water with one or more contaminants, salt water, and/or produced water. The vapor flowing from the evaporator 112 may be directed to the condenser 116. The condenser 116 may also be referred to as a heat exchanger or a cold heat exchanger. The condenser 116 may condense the vapor flowed from the evaporator 112. The expansion contraction ratio between the evaporator 112 side and the condenser 116 side may build up enough pressure to drive electrical generator 120-b, such as through a vapor turbine that may be positioned in the path of the vapor between the evaporator 112 and the condenser 116. The rotation of the vapor turbine may generally drive the electrical generator 120-b to generate electricity. A pump 114, such as a vacuum pump, may also be coupled with system 100-b. The pump 114 may hold the vacuum intensity while the heating and the cooling of the distillation process of system 100-b may generally move the vapor volume to drive the electrical generator 120-b.

Some embodiments of system 100-b include additional components. For example, some embodiments include a degasser to remove dissolved gases from the wastewater stream; the degas column may be positioned to remove dissolved gases from the fluid prior to the vapor from the vacuum distiller 110-b driving the electrical generator 120-b. Some embodiments include one or more mist eliminators positioned in at least an upper portion of the evaporator 112 or the degas column. Some embodiments include a vibrating plate or screen positioned at the upper portion of the degas column below a fluid level of the fluid in the degas column. The vibrating plate or screen may further facilitate gas removal from the fluid. Some embodiments include a membrane across the vibrating plate or screen, such as a reverse osmosis membrane. The membrane may further facilitate creating a cleaner fluid, such as cleaner water. Some embodiments include features as part of the degasser to facilitate access to the membrane for installation and removal purposes. Some embodiments include an electro-coagulation device or other electrolysis device to pre-treat the wastewater stream; the electro-coagulation device and/or an electrolysis device may positioned to pre-treat the fluid prior to the vapor from the vacuum distiller driving the electrical generator.

The wastewater stream may include a wide variety of streams that include, but are not limited to, water with one or more contaminants, salt water, and/or produced water.

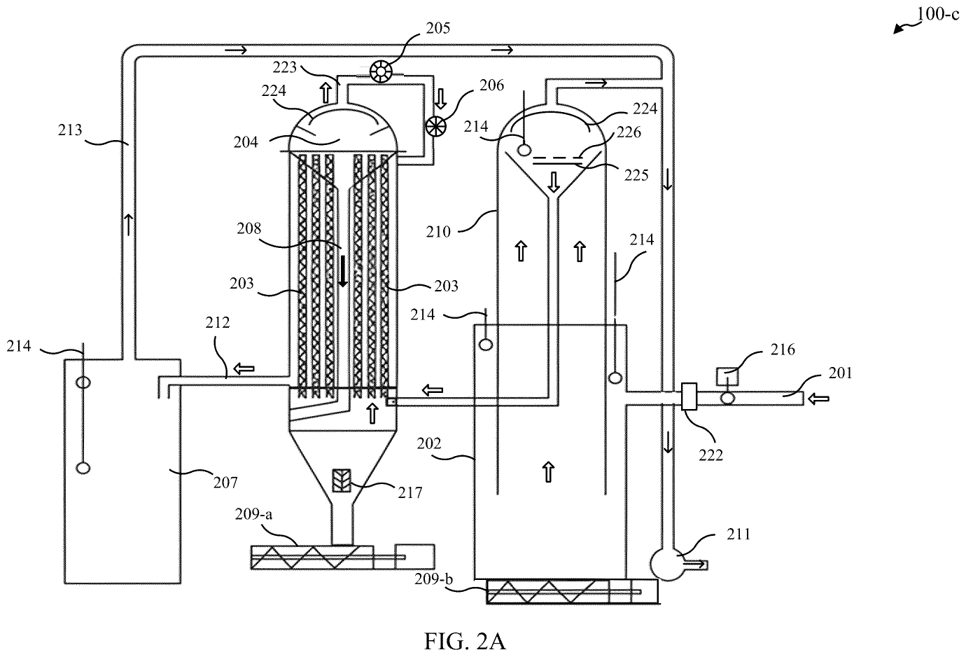

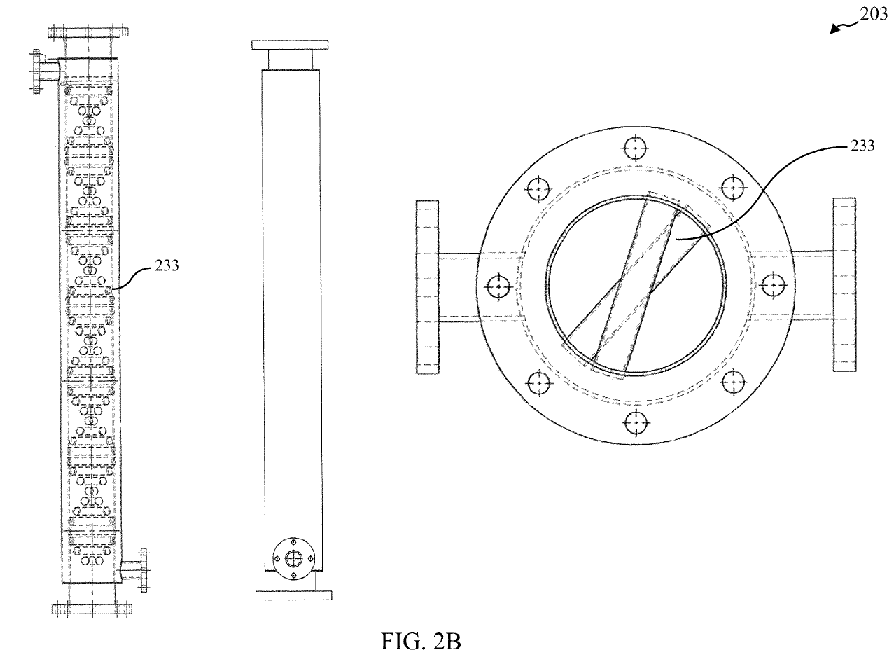

Turning now to FIG. 2A, a system 100-c is provided in accordance with various embodiments. System 100-c may be an example of system 100 of FIG. 1A and/or system 100-b of FIG. 1B. System 100-c may produce electricity from a vacuum distillation process. System 100-c may include a water inlet 201. Some embodiments of system 100-c include a barometric tank 202. Some embodiments include a heat exchanger 203. The heat exchanger 203 may also be referred to as a condenser and may be an example of condenser 116 of FIG. 1B. The heat exchanger 203 may condense vapor. Some embodiments include an expansion area 204. The expansion area 204 may also be referred to as part of a vaporization chamber, an evaporator, or an evaporation chamber, which may be an example of evaporator 112 of FIG. 1B; the heat exchanger 203 may also act as the evaporator along with acting as the condenser. The expansion area 204 may produce vapor through heating a fluid, such as a wastewater stream. The vapor may be directed to the heat exchanger 203 that may condense the vapor.

Some embodiments include a vapor turbine 205 coupled with an electrical generator 205. The vapor turbine 205 may be positioned between the expansion area 204 and the heat exchanger 203. The vapor directed to the heat exchanger 203 from expansion area 204 may create an expansion contraction ratio between the expansion chamber 204 and the heat exchanger 203 that may build up enough pressure to drive an electrical generator 205. The rotation of the vapor turbine 205 may generally drive the electrical generator 205. The vapor turbine 205 and the electrical generator 205 may be examples of the electrical generation components 120 of FIG. 1A and/or the electrical generator 120-b of FIG. 1B.

Some embodiments include a vapor blower 206. Some embodiments include a clean water tank 207. Some embodiments include a down flow tube 208. The down flow tube 208 may be positioned below a mist eliminator 224 positioned in the upper portion of the evaporator 204 to capture drops of fluid. Some embodiments include one or more solids removal units 209-a/209-b, which may further remove various solid impurities captured by the various components. Some embodiments include a degas column 210. The degas column 210 may also be referred to as a degasser. The degas column 210 may remove dissolved gases from the wastewater stream or fluid in general. The degas column 210 may be positioned to remove dissolved gases from the fluid prior to the vapor from the vacuum distiller driving the electrical generator 205. Some embodiments include one or more mist eliminators 224 positioned in at least an upper portion of the evaporator 204 or the degas column 210. Some embodiments include a vibrating plate or vibrating screen 225 positioned at the upper portion of the degas column 210 below a fluid level of the fluid in the degas column 210. The vibrating plate or screen 225 may further facilitate gas removal from the fluid. Some embodiments include a membrane 226 across the vibrating plate, such as a reverse osmosis membrane. The membrane 226 may further facilitate creating a cleaner fluid, such as cleaner water. Some embodiments include features as part of the degas column to facilitate access to the membrane for installation and removal purposes.

Some embodiments include a vacuum pump 211. The vacuum pump 211 may hold the vacuum intensity while the heating and the cooling of the distillation process may generally move the vapor volume to drive the electrical generation; vacuum pump 211 may be an example of pump 114 of FIG. 1B.

Some embodiments include a clean water conduit 212. Some embodiments include a vacuum conduit 213. Some embodiments include one or more liquid level control switches 214. The liquid level control switches 214 may help maintain proper liquid level. Some embodiments include one or more check valves 215. Some embodiments include a vortex breaker 217 that may facilitate stopping particulates from rotating such that they may fall straight down and be taken out by the solids removal device 209-a.

Some embodiments include additional components such as an electro-coagulation device or other electrolysis device to pre-treat the wastewater stream. The electro-coagulation device or an electrolysis device 222 may be positioned to pre-treat the fluid prior to the vapor from the vacuum distiller driving the electrical generator 205. The wastewater stream may include a wide variety of streams including, but not limited to, water with one or more contaminants, salt water, and/or produced water.

System 100-c may be configured for electrical generation. For example, as noted above, a rotating element such as the vapor turbine 205 may be positioned between the expansion area 204 and the heat exchanger 203. The vapor turbine 205 may be coupled with a vapor conduit 223. Vapor passing with respect to the vapor turbine 205 rotates the vapor turbine 205. The vapor turbine 205 may be coupled with an electrical generator 205 such that the vapor turbine 205 provides rotation for the generator to produce electricity. The other components generally shown may be described as a vacuum distillation system, such as the vacuum distillation components 110 of FIG. 1A and/or FIG. 1B.

Various heat sources may be utilized to form the vapor utilizing evaporator 203 such as a water heater, steam generator, refrigeration compressor, waste heat, heat from renewal energy sources (such as solar panels) or other closed-circuit method of producing heat.

FIG. 2B provides an example of heat exchanger 203 shown in FIG. 2A. A cross-sectional view, an exterior view, and a top-down view are provided. Heat exchanger 203 may be referred to as a spiral tube heat exchanger. The tubes 233 of the heat exchanger 203 may go around in a spiral nature. Heat exchanger 203 generally provides all the basic fundamentals for ideal heat exchange, surface area, contact, and temperature differentials. In additional, heat exchanger 203 generally has the added benefit of being self cleaning due to the flow and turbulence created by the design. This design generally allows higher surface area without the need for larger sized exchangers.

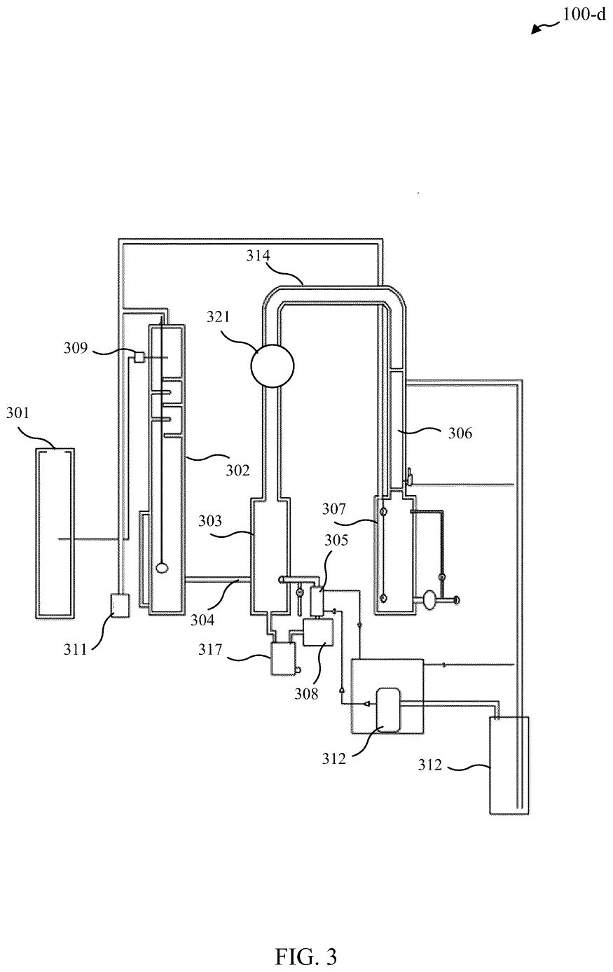

Turning now to FIG. 3, a system 100-d is provided in accordance with various embodiments. System 100-d may be an example of system 100 of FIG. 1A and/or system 100-b of FIG. 1B. System 100-d may include an electrolysis process 301. The electrolysis process 301 may include a dissociation of ions by electro-mechanical means, including, but not limited to, electromagnetic devices. In some embodiments, system 100-d includes a thin film degasser 302. In some embodiments, system 100-d includes an evaporation chamber 303 for vapor production. The evaporation chamber 303 may be an example of evaporator 112 of FIG. 1B. Some embodiments include a conduit 314 for directional flow of the vapor. The conduit 314 for directional flow of the vapor may also be referred to as a vapor duct. Some embodiments include a heat exchanger 305. Heat exchanger 305 may heat a product to a desired temperature; the heat exchanger 305 may act as part of the evaporator.

Some embodiments of system 100-d include a heat exchanger 306. Heat exchanger 306 may be an example of condenser 116 of FIG. 1B. The heat exchanger 306 may condense vapors to a liquid state. Some embodiments include a catch tank 307 for ultrapure product. Some embodiments include a circulation pump 308 for heat transfer. Some embodiments include a float switch and associated valve 309. The float switch and associated valve 309 may also be referred to as an automatic fill valve. The float switch and associated valve 309 may maintain proper liquid levels. Some embodiments include a product transfer pump.

System 100-d may include a vacuum pump 311. The vacuum pump 311 may be an example of pump 114 of FIG. 1B. In some embodiments of the system 100-d, an eductor or other mechanical means to lower pressure on the system are used in place of vacuum pump 311. Some embodiments include one or more heat sources 312 such as a water heater, steam generator, refrigeration compressor, waste heat, heat from renewal energy sources (such as solar panels) or other closed-circuit method of producing heat. Some embodiments include a cooling process 306. The cooling process 306 may include a refrigerated heat exchanger, water cooled heat exchanger, or air-cooled heat exchanger. Some embodiments of the system 100-d include a compound vacuum or pressure gauges. Compound vacuum or pressure gauges may determine pressure. Some embodiments include temperature indicators. Some embodiments include a waste ejection pump. Some embodiments include an auger 317. The auger 317 may provide for removal of semi solid material. Other removal devices may be utilized, such as a rotary vane pump, a positive displacement pump, a roto-lock valve, or other removal tools.

In some embodiments of the system 100-d, source water is piped into the electrolysis process 301. The source water may then enter the thin-film degasser 302 through the automatic fill valve 309. The water may then be transferred via conduit 304 to the evaporation chamber 303 where it may be pumped via a circulation pump 308 into the first heat exchanger 305 and may circulate back into the evaporation chamber 303 at an elevated temperature. Once it reaches the desired temperature in the evaporation chamber 303 being pulled under vacuum pump 311, the water may become vapor at an elevated rate. The vapor may be transferred via conduit 314 to the second heat exchanger 306 (an example of a condenser 116) whereupon it may condense and may be collected in the catch tank 307. The system may use various means to achieve the heating 312 and the cooling process 306, which may be monitored via various gauges and temperature indicators. The solid content removed from the source water during the process may be ejected from the system via pump or solids removal equipment 317 at the bottom of the evaporation chamber 303.

System 100-d may include one or more electrical generation components 321 (such as a rotating element and/or electrical generator), which may be an example of electrical generation 120 of FIG. 1A or electrical generation 120-b of FIG. 1B. For example, a rotating element 321 such as a vapor turbine may be positioned between the evaporation chamber 303 and the heat exchanger 306. The rotating element 321 may be coupled with conduit 314 for directional flow of the vapor. Vapor passing with respect to the rotating element 321 rotates the rotating element 321. The rotating element 321 may be coupled with an electrical generator 321 such that the rotating element 321 provides rotation for the generator to produce electricity. The other components generally shown may be described as a vacuum distillation system, such as the vacuum distillation components 110 of FIG. 1A and/or FIG. 1B.

Various heat sources may be utilized to form the vapor utilizing evaporator 303 such as a water heater, steam generator, refrigeration compressor, waste heat, heat from renewal energy sources (such as solar panels) or other closed-circuit method of producing heat.

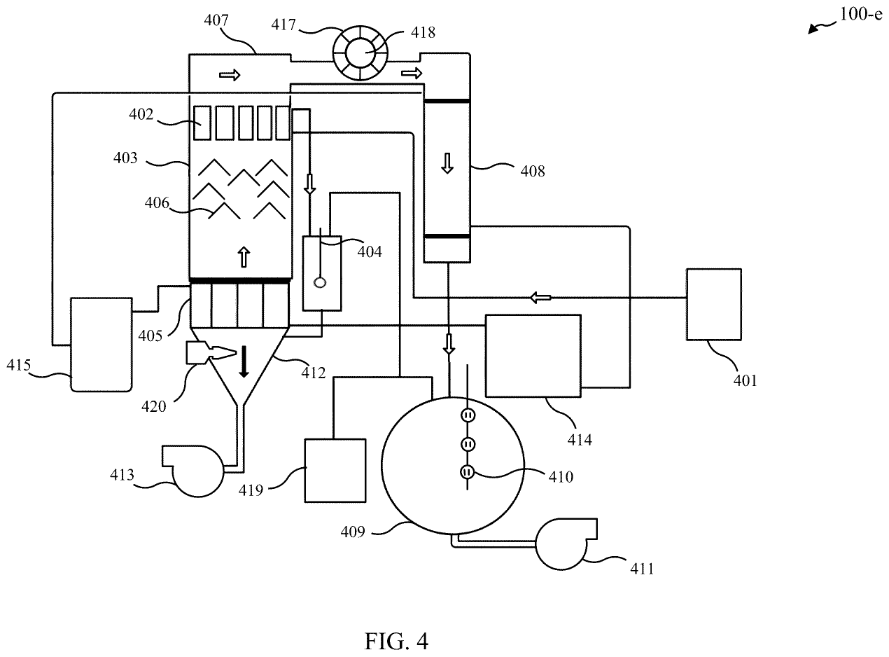

Turning now to FIG. 4, a system 100-e is provided in accordance with various embodiments. System 100-e may be an example of system 100 of FIG. 1A and/or system 100-b of FIG. 1B. System 100-e may include an electromechanical water conditioner 401.

Fluid may flow from the electromechanical water conditioner 401 to the pre-heat exchanger 402. Some embodiments of system 100-e include an expansion chamber 403. Expansion chamber 403 may also be referred to as an evaporator, a vaporization chamber, an evaporation chamber, or an expansion area, which may be an example of evaporator 112 of FIG. 1B. The expansion chamber 403 may include a hot heat exchanger 405. The expansion chamber 403 may produce vapor through heating a fluid with the hot heat exchanger 405, such as a wastewater stream or other fluid, as part of a distillation process. The vapor produced from the expansion chamber 403 may be directed to a condenser, such as a cold heat exchanger 408 through a steam vapor conduit 407. The cold heat exchanger 408 may be an example of condenser 116 of FIG. 1B. Some embodiments may include a mist eliminator 406. The cold heat exchanger 408 may condense the vapor. In some embodiments, the expansion contraction ratio between the expansion chamber 403 side and the cold heat exchanger 408 side may build up enough pressure to drive an electrical generator 418. The generator 418 may be positioned in the path of the vapor between the expansion chamber 403 and the cold heat exchanger 408. The generator 418 may include a rotating assembly 417.

The rotation of the rotating assembly 417 may generally drive the generator 418, creating electricity; these may be examples of electrical generation 120 of FIG. 1A and/or electrical generator 120-b of FIG. 1B. The other components generally shown may be generally described as a vacuum distillation system, such as the vacuum distillation components 110 of FIG. 1A and/or FIG. 1B.

Some embodiments include a pump, such as a vacuum pump 419. The vacuum pump 419 may hold the vacuum intensity while the heating and the cooling of the distillation process may generally move the vapor volume to drive the electrical generation. Vacuum pump 419 may be an example of pump 114 of FIG. 1B.

Some embodiments include additional components. Some embodiments include a cleanwater tank 409. The cleanwater tank 409 may include a multifunction float switch 410. Some embodiments include a clean water discharge pump 411. Some embodiments include a sludge collection chamber 412. Some embodiments include a sludge discharge pump 413.

The sludge discharge pump 413 may include an auger, rotary vane pump, a positive displacement pump, a roto-lock valve, or other tool for removal of semi solid material. Some embodiments include liquid level control 404 to help maintain proper liquid level inside of the sludge collection chamber and/or the expansion chamber 403. Some embodiments include a refrigeration compressor 414. Some embodiments include a condensing radiator 415. Some embodiments include a preheater 420.

System 100-e may be configured for electrical generation as noted above. For example, a rotating element such as the rotating assembly 417 may be positioned between the expansion chamber 403 and the heat exchanger 408. The rotating assembly may be coupled with a steam vapor conduit 407. Vapor passing with respect to the rotating assembly 417 rotates the rotating assembly 417. The rotating assembly 417 may be coupled with an electrical generator such that rotating assembly 417 provides rotation for the generator to produce electricity. The other components generally shown may be described as a vacuum distillation system, such as the vacuum distillation components 110 of FIG. 1A and/or FIG. 1B.

Various heat sources may be utilized to form the vapor utilizing evaporator 403 such as a water heater, steam generator, refrigeration compressor, waste heat, heat from renewal energy sources (such as solar panels) or other closed-circuit method of producing heat.

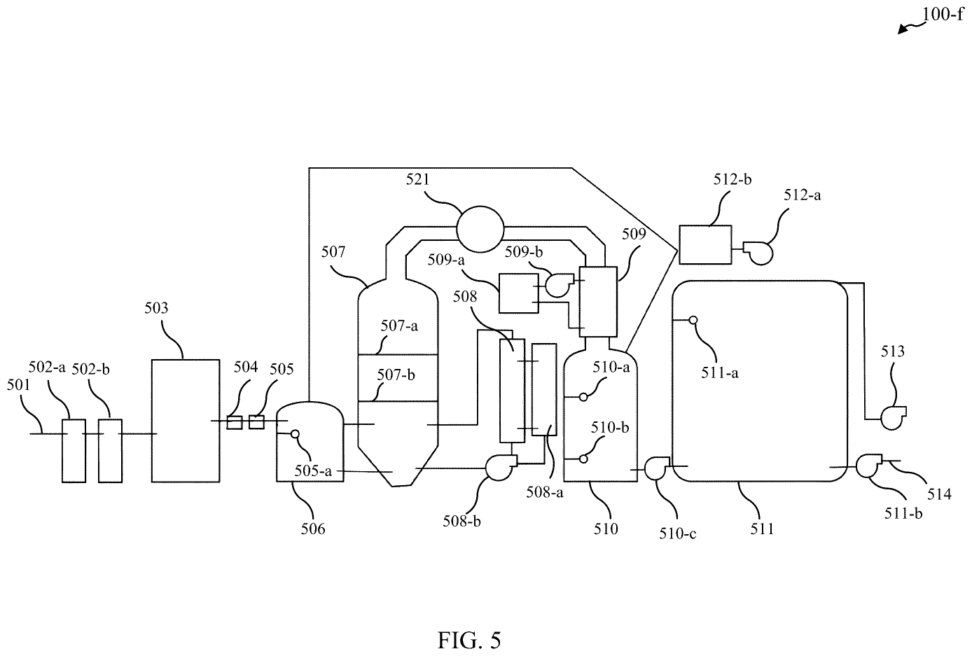

Turning now to FIG. 5, a system 100-f is provided in accordance with various embodiments. System 100-f may be an example of system 100 of FIG. 1A and/or system 100-b of FIG. 1B.

System 100-f may include a fluid inlet 501 followed by a filter train 502-a, which may include a 5 micron filter and/or filter train 502-b, which may include a carbon filter. Filter train 502-a and/or 502-b may filter a fluid, such as wastewater, flowing into system 100-f. The fluid flowing into system 100-f may include a wide variety of streams, including, but not limited to, water with one or more contaminants, salt water, and/or produced water. System 100-f may include a water softener 503 and/or an electromagnetic conditioner 504 to pre-treat the fluid. In general, the electromagnetic condition may include at least an electro-coagulation device or an electrolysis device positioned to pre-treat the fluid prior to a vapor from vacuum distillation driving electrical generator discussed below.

System 100-f may include a solenoid valve 505. The solenoid valve 505 may include a control switch 505-a, which may be utilized to control flow of the fluid into the system 100-f. System 100-f may also include a degas chamber 506 to remove gases from the fluid stream. The degas chamber 506 may be positioned to remove dissolved gases from the fluid prior to the vapor from the vacuum distiller driving the electrical generator.

System 100-f may include an evaporation chamber 507 and an evaporation heat exchanger 508 for evaporation; these may be examples of evaporator 112 of FIG. 1B. System 100-f may include a heat exchanger 509 for condensation, which may be an example of condenser 116 of FIG. 1B. The evaporation chamber 507 may include a fine mesh screen 507-a and/or a coarse mesh screen 507-b. The heat exchanger 508 (which may be referred to as the evaporator) may include a heating element 508-a and/or a circulation pump 508-b. The heat exchanger 508 may produce vapor through heating a fluid, such as a waste stream, with the heating element 508-a. The vapor may be directed to the heat exchanger 509. The heat exchanger 509 may include a cooling element 509-a and/or a circulation pump 509-b. The cooling element 509-a of heat exchanger 509 may condense the vapor. The expansion contraction ratio between the heat exchanger/evaporator 508 side and the heat exchanger/condenser 509 side may build up enough pressure to drive an electrical generator, such as through a rotating assembly 521 that may positioned in the path of the vapor between the heat exchanger 508 and the heat exchanger 509; this may provide an example of the electrical generation 120 of FIG. 1A and/or electrical generator 120-b of FIG. 1B. The rotation of the rotating assembly 521 may include an electrical generator. A pump, such as a vacuum pump 512-a, may also be coupled with the system, which may hold the vacuum intensity, while the heating and the cooling of the distillation process may generally move the vapor volume to drive the electrical generation. Pump 512-a may be an example of pump 114 of FIG. 1B.

System 100-f may also include additional components such as a collection chamber 510. The collection chamber 510 may include a high-on control switch 510-a and/or a low-off control switch 510-b. The collection chamber 510 may also include a pump 510-c.

System 100-f may include a storage tank 511. Storage tank 511 may include a full shut-down control switch 511-a and/or a pump 511-b. System 100-f may include a manifold 512-b and/or a blower 513. Manifold 512-b may be coupled with vacuum pump 512-a. A fluid outlet 514 may also be included.

In general, the components shown with respect to system 100-f provide for a vacuum distillation system, such as vacuum distillation components 110 of FIG. 1A and/or FIG. 1B, in combination with electrical generation through electrical generation components 521, such as electrical generation components of FIG. 1A and/or FIG. 1B.

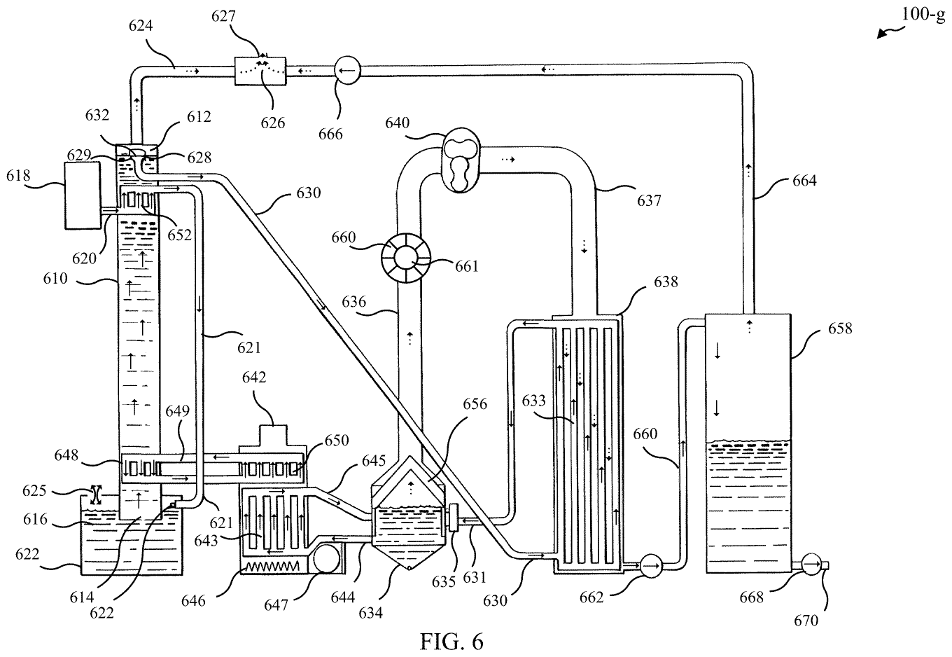

Turning now to FIG. 6, a system 100-g is provided in accordance with various embodiments. System 100-g may be an example system 100 of FIG. 1A and/or system 100-b of FIG. 1B.

System 100-g may include a vaporization chamber 634 that may be an example of evaporator 112 of FIG. 1B, a pump 640 that may be an example of pump 114 of FIG. 1B, and a condenser vessel 638 that may be an example of condenser 116 of FIG. 1B. System 100-g may include electrical generation (with vapor turbine or rotating assembly or element 660 and electrical generator 661) that may be an example of electrical generation 120 of FIG. 1A and electrical generator 120-b of FIG. 1B.

System 100-g may include a degasification and precipitation section, a vacuum distillation section, and a storage section. The sections may combine to result in a combined function greater than the sum of the functions of the individual sections.

The degasification and precipitation section may include a degasification precipitation tower 610, one or more sides, a tower top 612 and/or a tower bottom 614.

The tower 610 may be vertically oriented. The tower bottom 614 may be disposed or submerged within a supply tank 616.

Some embodiments of system 100-g include a source tank 618. Source tank 618 may include a fluid that may need to be distilled. The fluid may generally include water and impurities, which may include solutes or insoluble materials suspended in the water. Some fluids may include water as a solvent, and impurities, such as mineral salts and dust particles, commonly found in tap water. For example, in some embodiments, distilled water with less than one half percent (0.5%) impurities is obtained from a solution of tap water.

Some embodiments of system 100-g include supply lines 620 and 621 and one or more upper exchanger tubes 652. Supply lines 620 and 621 and the one or more upper exchanger tubes 652 may form a supply line connecting the source of fluid or source tank 618 and supply tank 616.

Some embodiments of system 100-g include a float valve 622 at the end of the supply line 621. The float valve 622 may be disposed within the supply tank 616 and may open and close to regulate the flow of fluid from the source tank 618 to the supply tank 616 responsive to the level of fluid in the supply tank 616. The float valve 622 may form supply control means connected to the supply line 621 for maintaining a desired supply level of the fluid within the supply tank 616.

The tower bottom 614 may be disposed below the desired supply level sufficiently so that regardless of any fluctuation in supply level permitted by operation of the float valve 622, the tower bottom 614 may remain submerged.

The tower 610 may be fluidly connected by tower duct 624 to tower vacuum means for maintaining a desired tower gas pressure on a surface of the fluid within the tower, in the form of vacuum pump 626. The vacuum pump 626 may reduce the gas pressure at the tower top 612 to as near an absolute pressure of zero as possible. It may exert an absolute pressure less than about two inches of mercury (<2 in Hg) on the fluid within the tank.

The absolute pressure is generally defined as atmospheric pressure minus vacuum. Standard absolute pressure is about 29.92 inches of mercury at 32° F. (32 in Hg 32° F.), or 14.696 pounds per square inch (psi). Thus, at standard conditions, the absolute pressure generally equals atmospheric pressure, and vacuum equals zero. For example, 2 in Hg absolute pressure in a vessel or system as used herein, with an atmospheric pressure of 29 in Hg is equivalent to “pulling 27 in Hg vacuum” on that vessel or system.

The surface of the fluid within the supply tank 616 may be exposed or fluidly connected to atmospheric pressure at vent 625. Thus, the differential pressure between the atmospheric pressure and the tower gas pressure may result in forcing the water upward within the tower 610 to a desired tower level of the fluid surface within the tower 610 proximate the top 612. Simple calculation may show the water level in the tower 610 may be over 20 feet above the water level in the supply tank 616.

Some embodiments of system 100-g include a fluid withdrawal device. The fluid withdrawal device may include a float 628 and a spacer 629 located proximate to the tower top 612. The float 628 may include a material that is buoyant in the fluid. The spacer 629 may be shaped to hold and extend, maintain, or submerge, a chamber line end 632 of a chamber line 630 just below the surface of the fluid proximate the tower top 612. Thus, the float 628 and spacer 629 may keep the chamber line end 632 submerged just below the surface of the fluid within the tower 610 despite any variation in the level of the fluid due to changes in the either the tower gas pressure or atmospheric pressure.

Some embodiments of system 100-g include a distillation section. The distillation section may include a vaporization chamber 634, a vapor duct in the form of vapor ducts 636 and 637 fluidly connecting the vaporization chamber 634 to the condenser vessel 638, vapor pump 640 fluidly connected in the vapor ducts between the ducts 636 and 637, and heater 642.

Some embodiments of system 100-g include level control 635. The level control 635 may regulate the flow of fluid from the tower 610 through the chamber line 630 and chamber line 631 to the vaporization chamber 634, opening a valve in the control 635 when the level in the chamber 634 falls below a desired chamber level and closing the valve when the level reaches the desired chamber level. The level control 635 may form chamber level control means connected to the chamber line 631 for maintaining a desired chamber level of the fluid within the chamber 634.

The vapor pump 640 may form means for transferring water vapor, from the vaporization chamber 634 to the condenser vessel 638 through the vapor ducts 636 and 637. The vapor pump 640 also may provide means for maintaining a selected chamber gas pressure within the chamber 634 that is related to a selected chamber temperature of fluid within the vaporization chamber 634 such that the selected chamber temperature is above the boiling point of the, water at the selected chamber pressure.

Some embodiments of system 100-g are configured for electrical generation. The system 100-g may include one or more electrical generation components 660/661. The electrical generation component(s) 660/661 may generally include a rotating element 660 and an electrical generator 661. The rotating element 660 such as a vapor turbine may be positioned between the vaporization chamber 634 and the condenser vessel 638. The rotating element 660 may be coupled with the vapor duct 636. In some embodiments, the rotating element 660 is coupled with the vapor duct 637. Vapor may pass with respect to the rotating element 660 and may rotate the rotating element 660. The rotating element 660 may be coupled with an electrical generator 661 such that the rotating element 660 provides rotation for the generator 661 to produce electricity as part of the electrical generation from the electrical generation components 660/661.

As the gas pressure on a liquid fluid decreases so may the boiling point of compounds within the fluid, although not in direct relation. For example, if the gas pressure on the fluid within the chamber 634 is reduced to less than eight inches of mercury (8 in Hg), the temperature at which the water in the fluid will boil may also be reduced to less than about 150° F. Correspondingly, a reduction to less than two inches of mercury (2 in Hg) may lower the boiling point of water within the fluid to 100° F. or less.

Thus, the selected chamber gas pressure exerted on the fluid within the vaporization chamber 634, may be related to the selected chamber temperature required to produce boiling or vaporization of the water. The system may facilitate distillation under varying conditions using different sources of water. If organics in the fluid have boiling points close to that of water at one pressure, the chamber may be selected for better separation. Alternatively, the system may accommodate various heat sources and temperatures by varying the vacuum. Various heat sources may be utilized to form the vapor utilizing chamber 634 such as a water heater, steam generator, refrigeration compressor, waste heat, heat from renewal energy sources (such as solar panels) or other closed-circuit method of producing heat.

Although the fluid within the chamber 634 may be heated directly, such as with common boilers, a heat exchanger may be used for the heater 642, as shown in FIG. 6. The heater 642 may include heater tubes 643 fluidly connected to the vaporization chamber 634, below the desired chamber level, for recirculation of the fluid through the heater tubes 643 by recirculation lines 644 and 645. As may be seen, a natural convection flow may result within the chamber 634 for the plumbing connections shown in FIG. 6, as cooler fluid is withdrawn into recirculation line 644, heated in the heater tubes 643, and flowed back through the recirculation line 645. The fluid may also be pumped from the chamber 634 to the heater 642 so as to cause an agitation of the chamber and heater contents, resulting in a more uniform temperature throughout the fluid as desired.

The heater 642 shown in FIG. 6 may only use one possible heat source, such as natural gas, supplied to forced air burners 646. A thermostat (not shown) on the heater may be set to maintain the fluid at the selected chamber temperature by regulating the flow of natural gas to the burners 646. Instead of regulating the burners, the flow of fluid between the chamber 634 and the heater 642 may be regulated with a suitable valve arrangement controlled by the thermostat, such as when using a constant heat source such as solar heated liquid. Thus, the heater 642 may provide heater means associated with the vaporization chamber 634 for maintaining the fluid within the chamber 634 at a selected chamber temperature. The selected chamber temperature may be substantially below the standard or atmospheric point of water.

Baffles may be placed within the vaporization chamber 634 above the desired chamber level to trap water droplets that may be withdrawn upward with water vapor. Such water droplets may tend to have contaminants still dissolved therein.

The cooled fluid, withdrawn from the tower top 612 through the chamber line end 632, may be flowed through the condenser exchanger tubes 633 to absorb heat from the water vapor pumped into the condenser vessel 638. The condenser exchanger tubes 633 may be fluidly connected in the chamber line between the lines 630 and 631.

A “Roots” or lobe-type gas pump may be used for the vapor pump 640 that may cause a pressure higher than the selected chamber gas pressure to be exerted on the condenser vessel 638 downstream from the vapor pump 640. Thus, increased gas pressure on the water vapor and a decrease in temperature of the vapor may result in condensation in the condenser vessel 638.

The gas pressure within the condenser vessel 638 may be greater than the chamber gas pressure but still substantially below atmospheric pressure.

The condenser vessel 638 may be fluidly connected to storage tank 658 by storage line 660. The storage line 660 may be connected to the condenser vessel 638 proximate to a bottom of the condenser vessel 638. Storage pump 652 may withdraw any water distillate from the condenser vessel 638 to the storage tank 658. The storage line 660 may be connected at the top of the storage tank 658.

The storage tank 658 may be fluidly connected at the top thereof to the vacuum pump 626 by storage duct 664. Storage vacuum means in the form of vacuum control valve 666 in the storage duct 664 may maintain the storage gas pressure exerted on the storage tank 658 not more than ten inches of mercury (10 in Hg) below atmospheric pressure.

In order to ensure that the water in the tank 658 remains pure, the check valve 668 in the dispensing line 670 may be connected to the storage tank 658 for dispensing the water distillate as needed. The check valve 668 may prevent contaminants from entering the storage tank 658 from the dispensing line 670.

The fluid within the tower 610 in the lower part of the tower, proximate the tower bottom 614, may be heated. Exchanger tubes 648 may be fluidly connected to heater tubes 650 of the heater 642 by heater lines 649. A separate thermostat (not shown) may regulate the recirculation of fluid between the heater 642 and the chamber 647. The temperature of the fluid at the exchange tubes 648 may exceed the boiling point of water at the tower pressure.

To prevent boiling of the fluid and the undesirable withdrawal and loss of water vapor from the fluid through the tower duct 624 and vacuum pump 626, the fluid may be cooled below the boiling point of water at the tower gas pressure by the upper exchanger tubes 652 disposed within the tower 610 near the top 612. The upper exchanger tubes 652 may be fluidly connected in the supply line between lines 620 and 621.

The heat exchangers described in the tower and elsewhere may include, but are not limited to, shell and tube counter flow type heat exchangers with the tower or vessel walls forming the shell within which one fluid flows about the tubes for heat exchange with separate fluid flowed within the tubes.

Thus, having described aspects of the system 100-g, the operation may be seen to occur as follows. Fluid, accumulated and stored in the source tank 618 may be at a cool temperature. The fluid may flow from the source tank 618 through the supply line 620 to the upper exchanger tubes 652. The cool fluid in the tubes 642 may absorb heat from the heated fluid in the tower 610 and may then flow through the supply line 621 to the float valve 622. As water is withdrawn from the tower top 612, the supply tank 616 level may fall, opening the float valve 622, and flowing fluid from the supply line 621 into the supply tank 616.

As the fluid flows through the open tower bottom 614 upward into the tower 610, it may flow past and absorb heat from the lower exchanger tubes 648 above but proximate the tower bottom 614. The heated fluid may travel upward through the tower 610 to the upper exchanger tubes 652. The fluid within the tower 610 may be cooled as it passes between the upper exchanger tubes 652 to a desired tower top 612 temperature well below the boiling point of water at the tower gas pressure exerted on the tower top 612 and created by the vacuum pump 626. The changes of temperature within the tower 610, and the very low tower gas pressure may be combined to cause degasification and precipitation of the fluid. The gases exit through vacuum pump outlet 627. The thusly treated fluid may not deposit substantial amounts of scale in the vaporization chamber and may not contaminate the distillate with gaseous impurities.

The cool, treated fluid may then be withdrawn through the spacer 629 below the float 628 into the end 632 of the chamber line 630. The fluid connection of the chamber line 630 at the top of the tower 612, which may not in most cases exceed 30 feet in height, may create a head for natural pressure flow through the condenser exchanger tubes 633. The cool, treated fluid may absorb heat from the water vapor pumped into the condenser vessel 638 from the vaporization chamber 634 as it flows through the condenser exchanger tubes 633.

The treated and heated fluid may then flow from the condenser exchanger tubes 633 through the chamber line 631 into the vaporization chamber 634 through the chamber level control 635. The chamber level control 635 may maintain the surface of the fluid within the chamber 634 at the desired level below the baffles 656. The fluid may be recirculated from the chamber 634 through the heater 642, and maintained at the selected chamber temperature by this heater means.

The chamber pressure and chamber temperature may be selected so that the selected chamber temperature may be above or at least the boiling point of water at the selected chamber pressure. The chamber pressure and temperature conditions may also be selected to obtain as pure a distillate as feasible from the fluid using as little heat and gas pump energy as possible.

As the vapor pump 640 maintains the selected chamber gas pressure in the chamber 634, the water within the fluid may boil, as the selected chamber temperature may exceed the boiling point of water at the selected chamber pressure. The flow of water vapor may tend to carry water droplets upward with the vapor pumped from the chamber 634 through the vapor duct 636, gas pump 640, and vapor duct 637 to the condenser vessel 638. The water droplets may collect on the baffles 656 and trickle down to the fluid in the chamber 634, instead of being carried to the condenser 638.

Once past the gas pump and into the condenser vessel 638, the water vapor may be subjected to a greater condenser gas pressure, and cooled as heat is exchanged with the cool fluid flowing from the tower 610 through the condenser exchanger tubes 633. Thus, the water vapor temperature may be reduced to the boiling point of water at the condenser gas pressure. As the water collects on the condenser exchanger tubes 633, the temperature of the water may be reduced below its boiling point as heat is further exchanged. The condensate may collect at the bottom of the condenser vessel 638.

The system may be operated for electrical generation. The system may include one or more electrical generation components 660/661. The electrical generation component(s) 660/661 may generally include a rotating element 660 and an electrical generator 661. The rotating element 660 such as a vapor turbine may be positioned between the vaporization chamber 634 and the condenser vessel 638. The rotating element 660 may be coupled with the vapor duct 636. In some embodiments, the rotating element 660 is coupled with the vapor duct 637. Vapor may pass with respect to the rotating element 660 and may rotate the rotating element 660. The rotating element 660 may be coupled with electrical generator 661 such that the rotating element 660 provides rotation for the electrical generator 661 to produce electricity as part of operating system 100-g.

The pure distillate water may then be withdrawn from the condenser vessel 638 by the pump 662, flowed to the top of the storage tank 658, and dumped into the storage tank 658. The water stored within the storage tank 658 may be maintained gas free by the exertion of a vacuum thereon that is substantially below atmospheric pressure but that is also not more than ten inches of mercury below atmospheric pressure. At the temperature of the water distillate within the storage tank, the gas pressure may be such that the distillate may be maintained substantially gas free, and an acceptable, insubstantial amount of water vapor may be withdrawn through the storage vacuum line 664.

Additional storage tanks (not shown) may be connected to the vacuum line 664. The additional storage tanks may be placed on the line in the event the storage tank 658 is filled. Even after filling however, the storage tank 658 may still be connected to the vacuum pump 626 through the vacuum valve 666 to maintain less than atmospheric gas pressure on the distillate within the storage tank 658.

System 100-g may also be configured for electrical generation. For example, a rotating element 660, such as a vapor turbine, may be positioned between the vaporization chamber 634 and the condenser vessel 638. The rotating element 660 may be coupled with the vapor duct 636 or vapor duct 637. Vapor passing with respect to the rotating element 660 rotates the rotating element. The rotating element 660 may be coupled with an electrical generator 661 such that the rotating element 660 provides rotation for the generator 661 to produce electricity. Rotating element 660 and electrical generator 661 may be examples of electrical generation 120 of FIG. 1A and/or electrical generator 120-a of FIG. 1B. The other components generally shown may be described as a vacuum distillation system, such as the vacuum distillation components 110 of FIG. 1A and/or FIG. 1B.

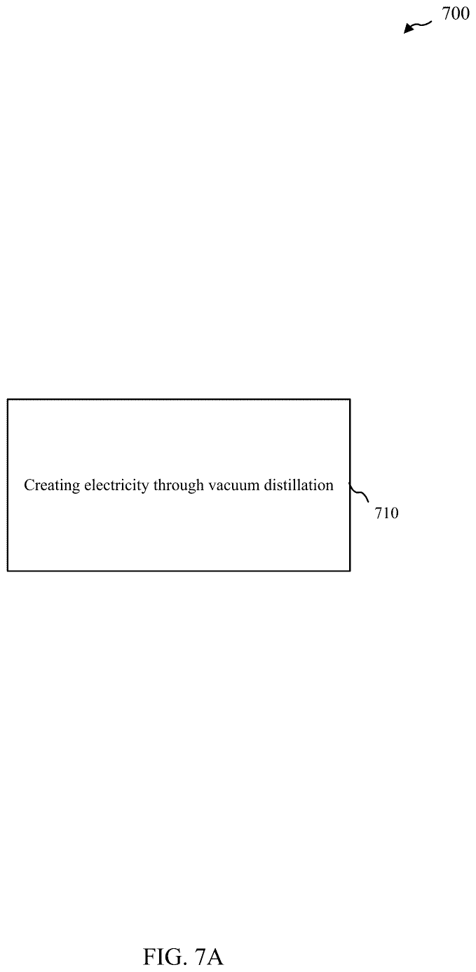

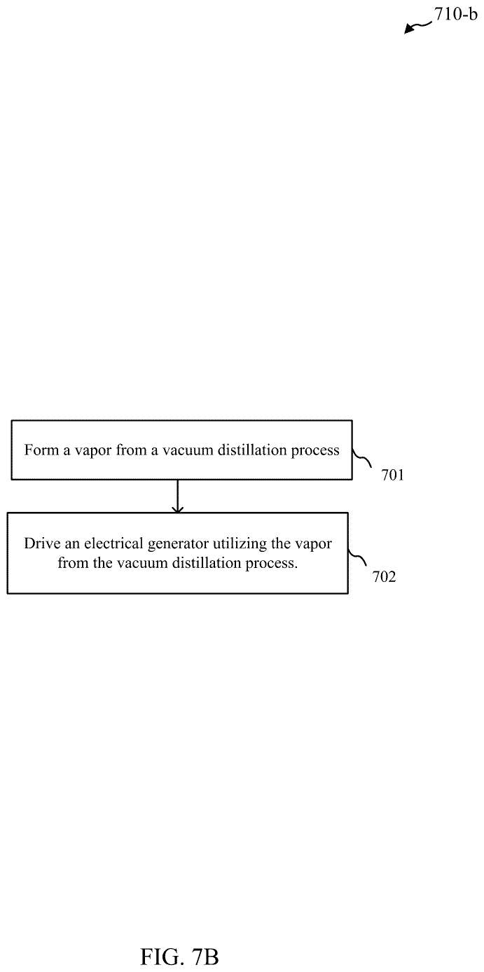

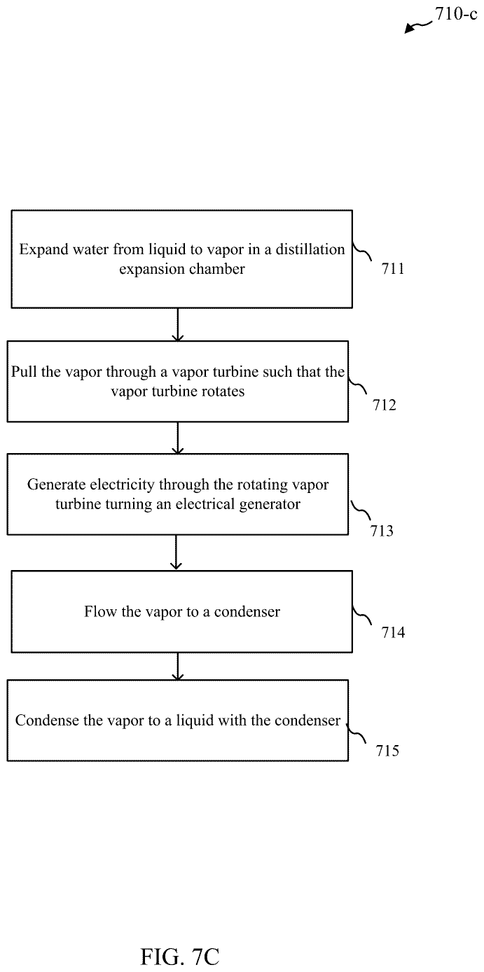

Turning now to FIG. 7A, a flow diagram of a method 700 is shown in accordance with various embodiments. Method 700 may be implemented utilizing a variety of systems and/or devices such as those shown and/or described with respect to FIG. 1A, FIG. 1B, FIG. 2A, FIG. 2B, FIG. 3, FIG. 4, FIG. 5, and/or FIG. 6.

At block 710, electricity is created through vacuum distillation. This may be done in a variety of ways as discussed herein. In general, vapor is produced as part of a vacuum distillation process that may drive one or more electrical generation components.

Turning now to FIG. 7B, a flow diagram of a method 710-b is shown in accordance with various embodiments. Method 710-b may be an example of method 700 of FIG. 7. Method 710-b may be implemented utilizing a variety of systems and/or devices such as those shown and/or described with respect to FIG. 1A, FIG. 1B, FIG. 2A, FIG. 2B, FIG. 3, FIG. 4, FIG. 5, and/or FIG. 6. In general, this method may involve producing electricity as part of a vacuum distillation process.

At block 701, a vapor may be formed from a vacuum distillation process. At block 702, an electrical generator may be driven utilizing the vapor from the vacuum distillation process. The method may include condensing the vapor after driving the electrical generator utilizing the vapor from the vacuum distillation process. Forming the vapor from the vacuum distillation process may include heating a fluid. An expansion contraction ratio between forming the vapor from the vacuum distillation process and condensing the vapor may build pressure to drive the electrical generator. Some embodiments further include utilizing a pump to hold a vacuum intensity with respect to the vacuum distillation process.

A wide variety of fluids may be utilized with respect to the method. For example, the fluid may include a wastewater stream. Some embodiments include pretreating the fluid prior to forming the vapor from the vacuum distillation process utilizing at least an electro-coagulation process or an electrolysis process. Some embodiments include removing dissolved gases from the fluid prior to forming the vapor from the vacuum distillation process. Some embodiments include removing droplets from the vapor between forming the vapor from the vacuum distillation process and driving the electrical generator utilizing the vapor from the vacuum distillation. Some embodiments include vibrating at least a plate or a screen positioned within the fluid as part of removing the dissolved gases from the fluid prior to forming the vapor from the vacuum distillation process. The vibrating plate or screen may further facilitate gas removal from the fluid. Some embodiments include a membrane across the vibrating plate, such as a reverse osmosis membrane. The membrane may further facilitate creating a cleaner fluid, such as cleaner water. Some embodiments include features as part of the degasser to facilitate access to the membrane for installation and removal purposes.

Turning now to FIG. 7C, a flow diagram of a method 710-b is shown in accordance with various embodiments. Method 710-b may be an example of method 700 of FIG. 7A and/or method 710-b of FIG. 7B. Method 710-c may be implemented utilizing a variety of systems and/or devices such as those shown and/or described with respect to FIG. 1A, FIG. 1B, FIG. 2A, FIG. 2B, FIG. 3, FIG. 4, FIG. 5, and/or FIG. 6. In general, this method may involve producing electricity as part of a vacuum distillation process.

At block 711, water may be expanded from liquid to vapor in a distillation expansion chamber. At block 712, the vapor may be pulled through a vapor turbine such that the vapor turbine rotates. At block 713, electricity may be generated through the rotating vapor turbine turning an electrical generator. At block 714, the vapor may flow to a condenser. At block 715, the vapor may be condensed to a liquid with the condenser.

These embodiments may not capture the full extent of combinations and permutations of materials and process equipment. However, they may demonstrate the range of applicability of the methods, devices, and/or systems. The different embodiments may utilize more or less stages than those described.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various stages may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the embodiments.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which may be depicted as a flow diagram or block diagram or as stages. Although each may describe the operations as a sequential process, many of the operations can be performed in parallel or concurrently. In addition, the order of the operations may be rearranged. A process may have additional stages not included in the figure.

Having described several embodiments, it will be recognized by those of skill in the art that various modifications, alternative constructions, and equivalents may be used without departing from the spirit of the different embodiments. For example, the above elements may merely be a component of a larger system, wherein other rules may take precedence over or otherwise modify the application of the different embodiments. Also, a number of stages may be undertaken before, during, or after the above elements are considered. Accordingly, the above description should not be taken as limiting the scope of the different embodiments.

What is claimed is:

1. 1. A method comprising:
forming a vapor from a vacuum distillation process; and
driving an electrical generator utilizing the vapor from the vacuum distillation process.

2. The method of claim 1, further comprising:
condensing the vapor after driving the electrical generator utilizing the vapor from the vacuum distillation process.

3. The method of claim 2, wherein forming the vapor from the vacuum distillation process includes heating a fluid.

4. The method of claim 3, wherein an expansion contraction ratio between forming the vapor from the vacuum distillation process and condensing the vapor builds pressure to drive the electrical generator.

5. The method of claim 4, further comprising utilizing a pump to hold a vacuum intensity with respect to the vacuum distillation process.

6. The method of claim 5, wherein the fluid includes a wastewater stream.

7. The method of claim 5, further comprising pretreating the fluid prior to forming the vapor from the vacuum distillation process utilizing at least an electro-coagulation process or an electrolysis process.

8. The method of claim 7, further comprising removing dissolved gases from the fluid prior to forming the vapor from the vacuum distillation process.

9. The method of claim 8, further comprising removing droplets from the vapor between forming the vapor from the vacuum distillation process and driving the electrical generator utilizing the vapor from the vacuum distillation.

10. The method of claim 9, further comprising vibrating at least a plate or a screen positioned within the fluid as part of removing the dissolved gases from the fluid prior to forming the vapor from the vacuum distillation process.

11. A system comprising:
a vacuum distiller; and
an electrical generator coupled with the vacuum distiller such that vapor from the vacuum distiller drives the electrical generator.

12. The system of claim 11, wherein the vacuum distiller includes an evaporator that produces the vapor through heating a fluid.

13. The system of claim 12, wherein the vacuum distiller includes a condenser that condenses the vapor produced from the evaporator, wherein an expansion contraction ratio between the evaporator and the condenser of the vacuum distiller builds pressure to drive the electrical generator.

14. The system of claim 13, further comprising a pump coupled with the vacuum distiller to hold a vacuum intensity for the system.

15. The system of claim 14, wherein the electrical generator includes a vapor turbine.

16. The system of claim 15, wherein the fluid includes a wastewater stream.

17. The system of claim 15, further comprising at least an electro-coagulation device or an electrolysis device positioned to pre-treat the fluid prior to the vapor from the vacuum distiller driving the electrical generator.

18. The method of claim 17, further comprising a degas column positioned to remove dissolved gases from the fluid prior to the vapor from the vacuum distiller driving the electrical generator.

19. The system of claim 18, further comprising one or more mist eliminators positioned in at least an upper portion of the evaporator or the degas column.

20. The system of claim 19, further comprising at least a vibrating plate or a vibrating screen positioned at the upper portion of the degas column below a fluid level of the fluid in the degas column.
